(19) United States
(12) Patent Application Publication
(10) Pub. No.: US 2026/0134056 A1
(43) Pub. Date: May 14, 2026

(54) APPARATUS AND METHOD FOR DEEP LEARNING OPERATION

(71) Applicant: POSTECH RESEARCH AND BUSINESS DEVELOPMENT FOUNDATION, Pohang-si (KR)

(72) Inventors: DONGYUN KAM, Pohang-si (KR); MyeongJi YUN, Pohang-si (KR); SUNWOO YOO, Pohang-si (KR); Youngjoo LEE, Pohang-si, Gyeongsangbuk-do (KR); Seungwoo HONG, Pohang-si (KR)

(21) Appl. No.: 19/387,290

(22) Filed: Nov. 12, 2025

(30) Foreign Application Priority Data
Nov. 14, 2024 (KR) 10-2024-0162441
Sep. 30, 2025 (KR) 10-2025-0142296

(51) Int. Cl. G06F 17/16

(52) U.S. Cl. CPC G06F 17/16

(57) ABSTRACT

A matrix operation method according to an embodiment is disclosed. The matrix operation method includes dividing a first matrix and a second matrix into a plurality of bit slices, respectively, identifying a slice vector including a predetermined value among at least one bit slice of the first matrix and the second matrix, and compressing the slice vector, skipping a matrix operation corresponding to the compressed slice vector, and performing a matrix operation on slices that are not skipped, performing a compensation operation to compensate for a value of the skipped matrix operation, and combining a result of the performed matrix operation with a result of the compensation operation to generate a final matrix operation result.

### CROSS-REFERENCE TO RELATED APPLICATIONS

This application claims the benefit of Korean Patent Application No. 10-2024-0162441, filed on Nov. 14, 2024, and Korean Patent Application No. 10-2025-0142296, filed on Sep. 30, 2025, in the Korean Intellectual Property Office, the entire disclosures of which are incorporated herein by reference for all purposes.

### BACKGROUND

### 1. Field of the Invention

One or more embodiments relate to an apparatus and a method for a deep learning operation, and more particularly, to an apparatus and a method for a deep learning operation using non-zero-point bit-slice sparsity in symmetric quantization.

### 2. Description of the Related Art

Deep learning technologies, particularly large-scale deep learning networks (DNNs), are playing a key role in various fields such as natural language processing, image recognition, robotics and the like. However, these models may require massive computation and memory access, resulting in significant energy consumption and slowdowns when deployed in resource-constrained environments such as smartphones and edge devices.

To address these issues, quantization techniques that reduce the bit-precision of weights and activation values in deep learning models are being widely studied. In particular, post-training quantization (PTQ), which performs quantization using simple calibration data without retraining, is attracting attention as an efficient approach for model lightweighting.

Among quantization techniques, symmetric quantization may be simple to implement by symmetrically mapping the data distribution around zero. However, when applied to asymmetric data distributions, which are common in actual deep learning models, symmetric quantization may suffer from inefficient use of the quantization range, significantly reducing model inference accuracy. To address this issue, asymmetric quantization may be proposed, which sets the quantization range by considering both minimum and maximum values of data.

To improve computational efficiency of a deep learning accelerator, bit-level sparsity technology may be used, which divides a bit representation of data into several pieces (e.g., bit-slicing) and skips operations on slices with a value “0” to reduce energy consumption. Symmetric quantization may be easy to apply this sparsity technology because values are concentrated around “0”, but model inference accuracy may be reduced, as described above. Asymmetric quantization, which has excellent accuracy, may have a limitation in that data distribution is formed around a predetermined zero-point rather than “0”, so “O” slices rarely occur, making it difficult to apply the existing bit-level sparsity technology.

Accordingly, there may be a growing demand for new deep learning acceleration technologies capable of maximizing computational efficiency while maintaining the high accuracy of asymmetric quantization.

The above information is presented as related art only to assist with an understanding of the disclosure. No determination has been made, and no assertion is made, as to whether any of the above might be applicable as prior art with regard to the disclosure.

### SUMMARY

According to an aspect, there is provided a matrix operation method including dividing a first matrix and a second matrix into a plurality of bit slices, respectively, identifying a slice vector including a predetermined value among at least one bit slice of the first matrix and the second matrix, and compressing the slice vector, skipping a matrix operation corresponding to the compressed slice vector, and performing a matrix operation on slices that are not skipped, performing a compensation operation to compensate for a value of the skipped matrix operation, and combining a result of the performed matrix operation with a result of the compensation operation to generate a final matrix operation result.

The matrix including the slice vector may include an asymmetric-quantized matrix.

The matrix operation method may further include adjusting a zero-point value used in the asymmetric quantization.

The matrix operation method may further include analyzing a value distribution of the asymmetric-quantized matrix, and determining a bit-width of the bit slice, based on the analyzed value distribution.

The asymmetric-quantized matrix including the slice vector may include the second matrix, the second matrix may include an activation matrix, and the first matrix may include a weight matrix.

The performing of the matrix operation may include processing a sparse operation corresponding to the compressed slice vector and a dense operation corresponding to an uncompressed slice vector in parallel on different operators.

The performing of the matrix operation may include in response to throughput of the sparse operation being less than throughput of the dense operation, additionally assigning and processing a dense operation to a sparse operator in an idle state.

The performing of the compensation operation may include performing the compensation operation by reusing the bit slices of the first matrix used for the matrix operation on the slices that are not skipped.

According to an aspect, there is provided a deep learning acceleration apparatus for performing a matrix operation including memory storing matrix data, one or more first operation units electrically connected to the memory, and configured to perform a first matrix operation including at least one high-order bit slice among high-order bit slices and low-order bit slices divided from a first matrix and a second matrix, one or more second operation units configured to perform a second matrix operation between the low-order bit slices, one or more compensation units configured to calculate an operation value corresponding to a compressed slice vector including a predetermined value among the high-order bit slices, and a post-processing unit configured to combine a result of the first matrix operation and the second matrix operation with the operation value of the one or more compensation units to generate a final matrix operation result, wherein the first operation unit may not perform the first matrix operation corresponding to the compressed slice vector.

The deep learning acceleration apparatus may be configured to perform an operation on an asymmetric-quantized matrix, and the one or more compensation units may be configured to calculate an operation value corresponding to a slice vector including a predetermined non-zero value that occurs in the asymmetric-quantized matrix.

The one or more compensation units may be configured to calculate the operation value by reusing bit slices of the first matrix provided to the first operation unit for the first matrix operation.

The post-processing unit may further include a shift unit configured to adjust a bit-width of bit slices according to a value distribution of the matrix data.

The first operation unit may be configured to additionally assign and process the second matrix operation, in response to sparsity of the high-order bit slices being greater than or equal to a predetermined threshold value.

The first matrix may include a weight matrix, and the second matrix may include an activation matrix.

The deep learning acceleration apparatus may further include a register configured to store an adjusted zero-point value provided externally, wherein the one or more compensation units may be configured to calculate the operation value using an adjusted zero-point value stored in the register.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a conceptual diagram illustrating a processing flow of matrix data performed in an inference process of a deep learning model;

FIG. 2 is a diagram illustrating a concept of an asymmetrically-quantized bit-slice general matrix multiplication (AQS-GEMM) operation, according to an embodiment;

FIG. 3 is a block diagram illustrating an overall hardware architecture of a deep learning acceleration apparatus performing an AQS-GEMM operation;

FIG. 4 is a diagram illustrating graphs comparing and evaluating a throughput of a deep learning acceleration apparatus, according to an embodiment;

FIG. 5 is a conceptual diagram illustrating a process of improving bit-slice sparsity through zero-point manipulation (ZPM);

FIG. 6 is a conceptual diagram illustrating a distribution-based slicing (DBS) technique applying a bit-slicing scheme differently depending on distribution characteristics of data, according to an embodiment;

FIG. 7 is a flowchart illustrating an overall data processing flow including a post-training quantization (PTQ) calibration operation and a DNN inference operation, according to an embodiment;

FIG. 8 is a diagram illustrating a layout of major components of a deep learning acceleration apparatus implemented on an integrated circuit (IC), according to an embodiment;

FIG. 9 is a diagram illustrating graphs comparing and evaluating the performance of deep learning acceleration apparatuses from various aspects;

FIG. 10 is a flowchart illustrating a matrix operation method; and

FIG. 11 is a diagram conceptually illustrating a specific execution process of an AQS-GEMM operation.

### DETAILED DESCRIPTION

The following structural or functional descriptions of embodiments described herein are merely intended for the purpose of describing the embodiments described herein and may be implemented in various forms. The embodiments are not construed as limited to the disclosure and should be understood to include all changes, equivalents, and replacements within the idea and the technical scope of the disclosure.

Although terms such as “first” or “second” are used to explain various components, the components are not limited to the terms. These terms should be used only to distinguish one component from another component. For example, a first component may be referred to as a second component, and similarly, the second component may also be referred to as the first component.

When it is mentioned that one component is “connected” or “accessed” to another component, it may be understood that the one component is directly connected or accessed to another component or that still other component is interposed between the two components. On the contrary, it should be noted that if it is described that one component is “directly connected” or “directly joined” to another component, a third component may be absent. Expressions describing a relationship between components, for example, “between”, “directly between”, “neighboring”, or “directly neighboring”, etc., should be interpreted to be alike.

The singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art and the present disclosure, and are not to be construed as an ideal or excessively formal meaning unless otherwise defined herein.

The embodiments may be implemented as various types of products such as, for example, a personal computer, a laptop computer, a tablet computer, a smartphone, a television, a smart home appliance, an intelligent vehicle, a kiosk, and a wearable device. Hereinafter, embodiments are described in detail with reference to the accompanying drawings. In the drawings, like reference numerals are used for like elements.

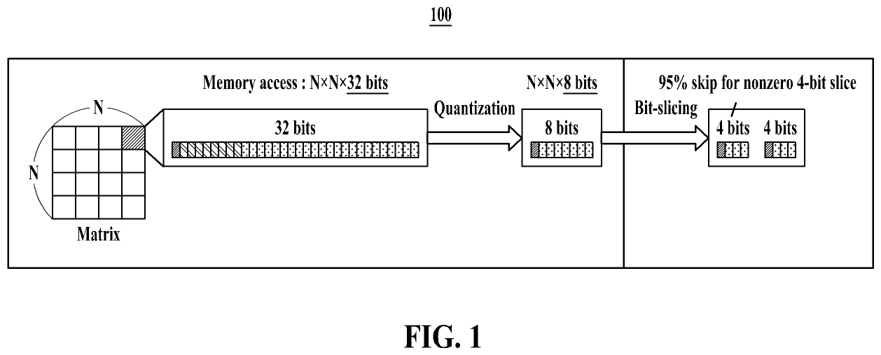

FIG. 1 is a conceptual diagram illustrating a processing flow of matrix data performed in an inference process of a deep learning model.

A deep learning operation according to an embodiment may include an operation on one or more matrices. A matrix illustrated in FIG. 1 may be, for example, a weight matrix, which is a set of learned parameters of a deep neural network (DNN), or an activation matrix generated as an intermediate result in an operation process of a deep learning model. A matrix may have an arbitrary size, such as N×N, and each element or data of the matrix may initially have relatively high precision, such as 32-bit floating-point.

High-precision data accessed from memory may be converted into lower-precision data, such as 8-bit integers, through a quantization process. Quantization may be a process of compressing a range of representation by reducing a bit-width of data, which may effectively reduce memory usage and computational complexity. In particular, an asymmetric quantization scheme considering the actual distribution of data may be applied to minimize the loss of model accuracy.

Data quantized to 8 bits may be divided into a plurality of slices through a bit-slicing process to improve computational efficiency. Bit-slicing may be a process of dividing a single piece of integer data into a plurality of segments or pieces. For example, 8-bit data may be split into two bit slices, each having a size of 4 bits. The split bit slices may include a high-order bit slice including high-order bits of the data and a low-order bit slice including low-order bits of the data. Numbers such as 32 bits, 8 bits, and 4 bits shown in FIG. 1 are merely an example for ease of description, and the precision of the data or the bit-width of the slices to be divided are not limited thereto and may be changed in various manners.

An existing bit-slice-based deep learning accelerator may be dependent on an important premise to improve computational efficiency. The premise is that a significant number of data values to be operated on may be “0” or very close to “0”. Under this assumption, when data is divided into multiple bit slices, the high-order bit slices may mostly be filled with 0 values such as “0000”. The accelerator may reduce the overall amount of computation and improve energy efficiency by identifying slices including only “0” and skipping multiplication operations (weight×0=0) including those slices.

This approach may work very effectively in a symmetric quantization environment. Symmetric quantization may set a quantization range such that a distribution of data is symmetrical to the left and right around “0”. Therefore, quantized data values may be naturally concentrated around “0”, which may increase a probability that a high-order bit slice is “0”, providing many opportunities for an existing accelerator to skip operations.

However, asymmetric quantization may fundamentally change this premise.

Asymmetric quantization may flexibly set the quantization range to match an actual distribution (e.g., minimum and maximum values) of the data, to minimize loss of model accuracy. In this process, a “0” value of original data may be mapped to a predetermined value referred to as a “zero-point (zp)”, not the “0” of the quantized data. As a result, the data distribution may be centered around the “zp” value, rather than “0”.

This change in distribution may have a critical impact on bit-slicing. Because the data is clustered around the “zp”, when the data is divided into bit slices, the high-order bit slice may no longer be “0000”. In place of “0000”, a predetermined “non-zero pattern” (e.g., when the zp is 33, “0010”) corresponding to a high-order bit of the zp value may occur most frequently.

Because the existing bit-slice accelerator is designed to identify and skip only slices including only “0”, the existing accelerator may not recognize the “non-zero patterns” that frequently occur in an asymmetric quantization environment as sparse and may have to perform all operations directly. As a result, although asymmetric quantization increases the accuracy of a model, it may be difficult to increase hardware efficiency because the existing accelerator provides few opportunities to skip operations.

A deep learning acceleration apparatus according to an embodiment may perform a post-training quantization calibration operation prior to performing an actual inference operation. In the calibration operation, data distribution characteristics of a matrix to which asymmetric quantization is to be applied may be analyzed using a calibration dataset prepared in advance. Through this analysis process, a pattern including a predetermined non-zero value that occurs most frequently in the high-order bit slice may be identified in advance.

Additionally, during the calibration operation, an optimization process may be performed to increase the frequency of occurrence of the identified predetermined non-zero value pattern. As an example of the optimization, a zp value of asymmetric quantization may be adjusted. Adjusting the zp value may cause more data to have the aforementioned pattern by making the center of the data distribution coincide with the center of a range where the predetermined non-zero value pattern occurs. As another example of the optimization, a bit-width of a bit slice may be dynamically determined based on a shape of the analyzed data distribution, for example, a standard deviation.

In the actual inference operation, the deep learning acceleration apparatus may identify the high-order bit slices of an input matrix. When an identified high-order bit slice matches a predetermined non-zero value pattern previously identified in the calibration operation, a general matrix multiplication operation corresponding to that slice may be skipped and not performed.

Since a result value of the skipped operation is not “0”, a separate compensation operation may be performed to compensate for the result value. The compensation operation may be performed by reusing data already fetched from memory for operations on other bit slices that have not been skipped. The compensation operation that reuses data may improve energy efficiency and processing speed of the overall operation process by minimizing additional memory access.

FIG. 1 shows that operations on 4-bit slices with non-zero values may be skipped at a high rate, such as 95%. By using an operation scheme using non-zero bit-slice sparsity, high energy efficiency of bit-slicing-based operations may be achieved while maintaining high inference accuracy provided by asymmetric quantization.

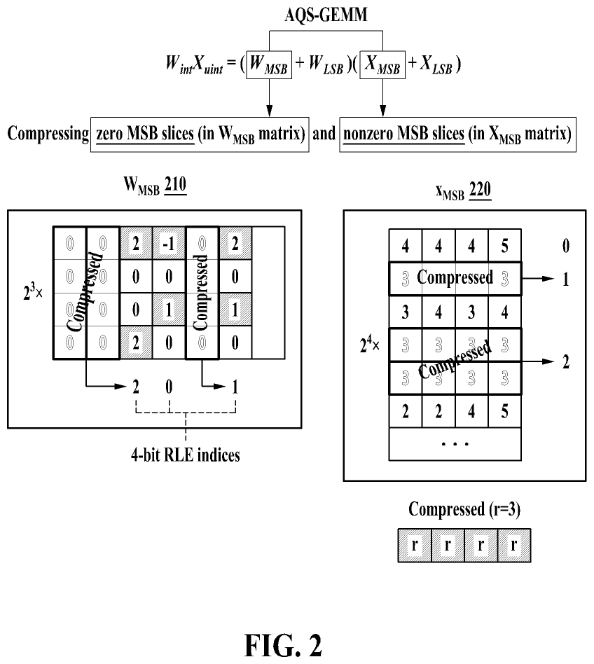

FIG. 2 is a diagram illustrating a concept of an asymmetrically-quantized bit-slice general matrix multiplication (AQS-GEMM) operation, according to an embodiment. The configurations and operations described with reference to FIG. 1 may be applied in a similar manner or with slight modifications to the embodiment of FIG. 2. Accordingly, in the description of FIG. 2, a detailed description of the substantially similar parts already described with reference to FIG. 1 will be omitted.

According to an embodiment, AQS-GEMM may be a matrix multiplication operation scheme that improves computational efficiency by using bit-slice sparsity for a matrix to which asymmetric quantization is applied. Bit-slice sparsity according to an embodiment may refer to a characteristic in which, when matrix data is divided into a plurality of bit slices, slices having a particular pattern occur at a high rate. For example, a matrix may have high bit-slice sparsity when most of the high-order bit slices of the matrix include “0” or a predetermined value. An operation apparatus may use this sparsity to improve overall computational efficiency by skipping or simplifying operations on slices having particular patterns.

In an AQS-GEMM operation according to an embodiment, an integer matrix multiplication operation Wᵢₙₜ*Xᵤᵢₙₜ may be decomposed into a plurality of sub-matrix operations through bit-slicing. For example, a first matrix Wᵢₙₜ may be divided into a high-order bit slice matrix W_{MSB} and a low-order bit slice matrix W_{LSB}. Similarly, a second matrix Xᵤᵢₙₜ may be divided into a high-order bit slice matrix X_{MSB} and a low-order bit slice matrix X_{LSB}. As a result, the original matrix multiplication may be expressed as a sum of four sub-matrix multiplication operations, such as (W_{MSB}+W_{LSB}) (X_{MSB}+X_{LSB}). The first matrix Wᵢₙₜ may be a symmetric quantized weight matrix, and the second matrix Xᵤᵢₙₜ may be an asymmetric-quantized activation matrix.

The left side of FIG. 2 may show a compression process of a weight matrix W_{MSB} 210 including high-order bit slices. A particular slice vector within the W_{MSB} 210, for example, a vector in which all components are “0” among column vectors, may be identified. A slice vector in which all components are “0” may be designated as a compressed target, and a position and information of the slice vector may be expressed in a concise form such as a 4-bit run-length encoding (RLE) index.

The right side of FIG. 2 may show a compression process of an activation matrix X_{MSB} 220 including high-order bit slices. A particular slice vector within the X_{MSB} 220, for example, a vector in which all components are equal to a predetermined non-zero value r (e.g., r=3) among row vectors, may be identified. A slice vector in which all components are equal to a predetermined value r may be designated as a compressed target.

The AQS-GEMM operation may compress both slice vectors including “0” that occur in symmetric quantized matrices and slice vectors including a predetermined non-zero value r that frequently occur in asymmetric-quantized matrices. Matrix operations corresponding to compressed slice vectors may be skipped or replaced with simpler forms of compensation operations, thereby improving the efficiency of the overall operation.

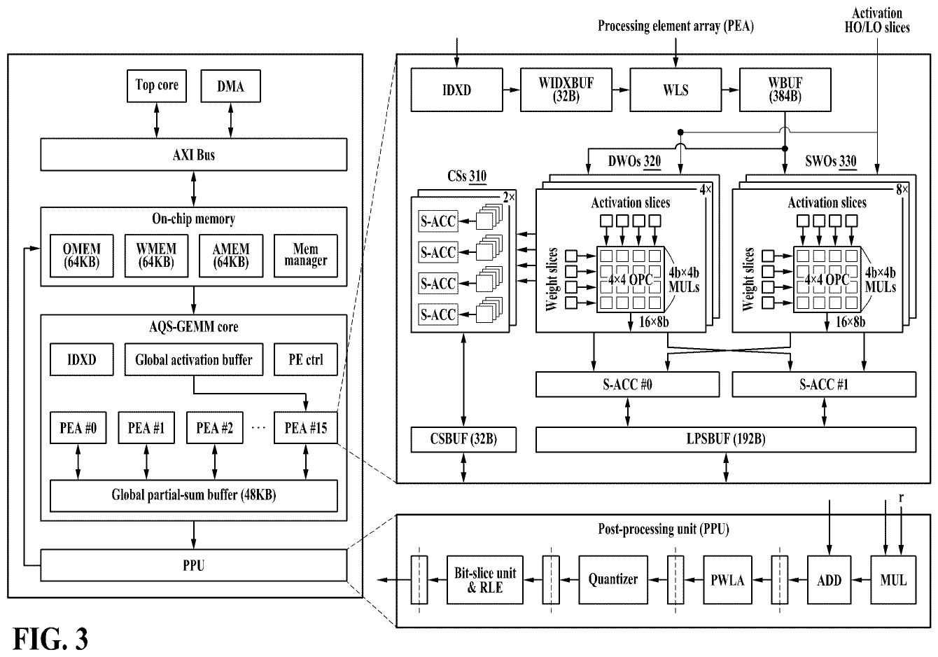

FIG. 3 is a block diagram illustrating an overall hardware architecture of a deep learning acceleration apparatus performing an AQS-GEMM operation. The configurations and operations described with reference to FIGS. 1 and 2 may be applied in a similar manner or with slight modifications to the embodiment of FIG. 3. Accordingly, in the description of FIG. 3, a detailed description of the substantially similar parts already described with reference to FIGS. 1 and 2 will be omitted.

A deep learning acceleration apparatus according to an embodiment may include an AQS-GEMM core, an on-chip memory, and a post-processing unit (PPU). However, not all the illustrated components are essential. The deep learning acceleration apparatus may be implemented by more or less components than the illustrated components. Such structure may be designed to minimize memory accesses by maximizing the reuse of data loaded from the on-chip memory.

The AQS-GEMM core according to an embodiment may be a core part in which actual matrix operations are performed, and may include a plurality of processing element arrays (PEAs). A PEA may include a workload scheduler (WLS), dynamic workload operation units (DWOs) 320, static workload operation units (SWOs) 330, and compensators (CSs).

When an AQS-GEMM operation is expressed as a sum of four sub-matrix multiplication operations (W_{MSB}*X_{MSB}, W_{LSB}*X_{MSB}, W_{MSB}*X_{LSB}, W_{LSB}*X_{LSB}), such as (W_{MSB}+W_{LSB}) (X_{MSB}+X_{LSB}), each operation may be assigned to a different unit depending on its characteristics.

A sparse operation according to an embodiment may be an operation in which at least one high-order bit slice is included and thus there is a high probability that an operation is to be skipped. For example, the operations W_{MSB}*X_{MSB}, W_{LSB}*X_{MSB}, and W_{MSB}*X_{LSB} may include a high-order bit slice W_{MSB} Or X_{MSB}, so the operations may have sparse characteristics because a compressed slice vector often does not perform an actual multiplication operation. A dense operation may be an operation that has a low probability of being skipped, for example, the operation W_{LSB}*X_{LSB} between low-order bit slices may have dense properties because in most cases an actual multiplication operation should be performed.

According to an embodiment, the DWOs 320 may be an embodiment of a first operation unit configured to process such sparse operations. According to an embodiment, the SWOs 330 may be an embodiment of a second operation unit configured to exclusively process dense operations (W_{LSB}*X_{LSB}).

Additionally, the PEA may include CSs 310. The CSs 310 according to an embodiment may be an embodiment of a compensation unit configured to perform an operation to compensate for a result value of a slice vector in which an operation is skipped by including a predetermined non-zero value r.

An overall AQS-GEMM operation, including a compensation operation according to an embodiment, may be conceptually decomposed into three parts: a bit-slice GEMM part, a compensation term part, and a pre-calculated term part.

The bit-slice GEMM part may include operations between uncompressed slice vectors. For example, the DWOs 320 may perform an outer-product operation between an uncompressed weight slice W_{MSB} or W_{LSB} and an uncompressed high-order bit activation slice X_{MSB} U.

The compensation term part may be a process of determining an operation value for a compressed slice vector. The CSs 310 may be configured to determine the compensation term. The CSs 310 may reuse the weight slices W_{MSB} and W_{LSB} previously provided to the DWOs 320 to determine the bit-slice GEMM part. Specifically, the CSs 310 may generate a compensation term by performing an operation between a sum (W_{MSB}+W_{LSB}) of the reused weight slices and a vector including a predetermined non-zero value r. The reuse of data may minimize data movement during operation processes and maximize energy efficiency by eliminating the need to reload the weights corresponding to the compressed slices from memory.

The pre-calculated term part may include an offset or bias term b′ that may be pre-calculated before the start of an operation, and this value may be combined with other operation results during post-processing.

The PPU may be an embodiment of a post-processing unit configured to combine operation results from the DWOs 320, the SWOs 330 and the CSs 310 to generate a final matrix operation result. In addition to the combining function, the PPU may perform additional post-processing tasks such as nonlinear function processing, requantization (e.g., Quantizer), bit-slicing, and RLE encoding.

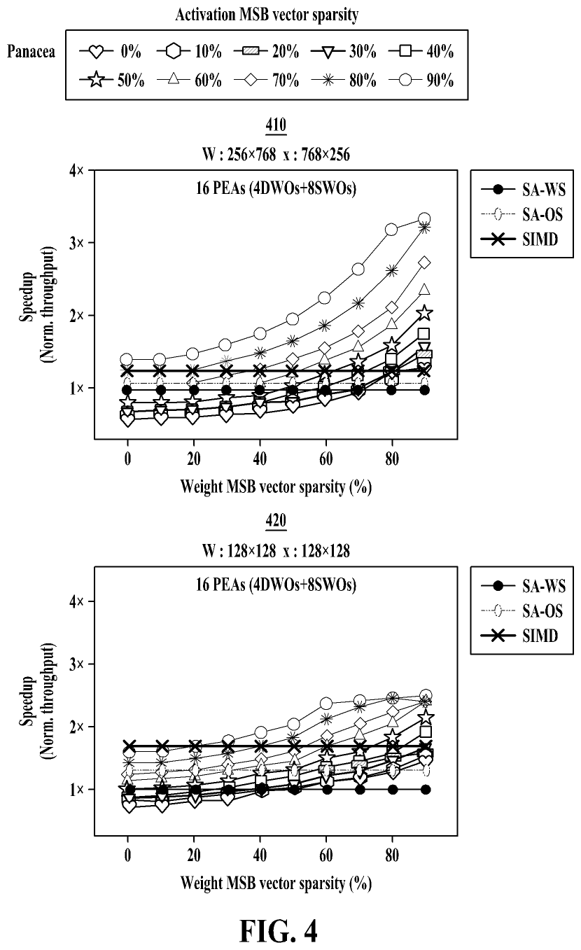

FIG. 4 is a diagram illustrating graphs comparing and evaluating a throughput of a deep learning acceleration apparatus according to an embodiment. The configurations and operations described with reference to FIGS. 1 to 3 may be applied in a similar manner or with slight modifications to the embodiment of FIG. 4. Accordingly, in the description of FIG. 4, a detailed description of the substantially similar parts already described with reference to FIGS. 1 to 3 will be omitted.

A horizontal axis of each graph may represent a high-order bit slice (weight most significant bit (Weight MSB)) vector sparsity of a weight matrix expressed as a percentage, and a vertical axis may represent a normalized throughput or speedup compared to a predetermined base architecture.

Graphs 410 and 420 may illustrate the performance of a plurality of architectures, for example, systolic array-weight stationary (SA-WS), systolic array-output stationary (SA-OS), and single instruction, multiple data (SIMD) architectures. Additionally, the performance of a proposed acceleration apparatus (e.g., Panacea) may be illustrated by multiple curves depending on a variation (e.g., from 0% to 90%) of a high-order bit slice (Activation MSB) vector sparsity of an activation matrix.

The graph 410 on the left side of FIG. 4 may show a throughput for a relatively large matrix (e.g., W: 256×768, x: 768×256). In this example, the acceleration apparatus may include 16 PEAs, each of which may be configured with four DWOs and eight SWOs. In a section where the high-order bit slice vector sparsity of the weight matrix is low, i.e., a section where the high-order bit slices are dense, excessive operations may be allocated to a relatively small number of DWOs, which may cause a bottleneck and limit throughput. However, as the vector sparsity of both the weight matrix and activation matrix increases, the throughput of the proposed acceleration apparatus may be significantly improved compared to other architectures.

The graph 420 on the right side of FIG. 4 may show a throughput for a relatively small matrix (e.g., W: 128×128, x: 128×128). Even if the matrix size changes, the overall trend of improved throughput as vector sparsity increases may be similar. These graphs show that the processing performance of an acceleration apparatus is closely related to the sparsity of the matrix data being processed, and that performance characteristics may be determined by the configuration of internal operation units.

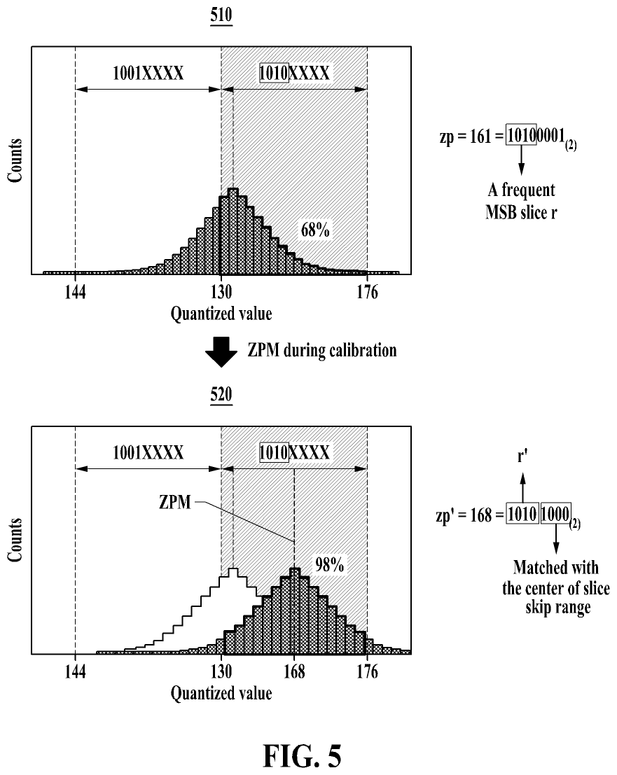

FIG. 5 is a conceptual diagram illustrating a process of improving bit-slice sparsity through zero-point manipulation (ZPM). The configurations and operations described with reference to FIGS. 1 to 4 may be applied in a similar manner or with slight modifications to the embodiment of FIG. 5. Accordingly, in the description of FIG. 5, a detailed description of the substantially similar parts already described with reference to FIGS. 1 to 4 will be omitted.

A graph 510 of FIG. 5 may illustrate a data distribution before ZPM is applied. Data to which asymmetric quantization is applied may be distributed around a predetermined zp, for example, 161. In this case, a most frequently occurring pattern r in an MSB slice may be “1010”, which corresponds to a high-order bit of the zp value 161. A slice skip range, in which operations may be skipped, may be set to a predetermined section including the above-mentioned pattern r. In the graph 510, only about 68% of the total data is located within the slice skip range, so an efficiency improvement effect through the skipping of operations may be limited.

A graph 520 of FIG. 5 may illustrate a data distribution after ZPM is applied in a calibration operation. ZPM may be a process of adjusting an original zero-point value zp to a new zero-point value zp′ (e.g., 168) through a predetermined operation. As the zero-point value is adjusted to 168, the center of the data distribution may be shifted to match the center of the slice skip range. In this case, the most frequently occurring high-order bit slice pattern r′ may still remain “1010”, but the proportion of data falling within the slice skip range may increase significantly, such as 98%.

Through this ZPM process, the frequency of occurrence of slice vectors including predetermined non-zero values may be artificially increased, resulting in improved processing efficiency of the deep learning acceleration apparatus by skipping more operations in the actual inference operation.

The specific numerical values such as the zero-point values, data distribution ratios, and high-order bit slice patterns shown in FIG. 5 may be examples for ease of description, and the scope of the ZPM technique is not limited by the shown numerical values.

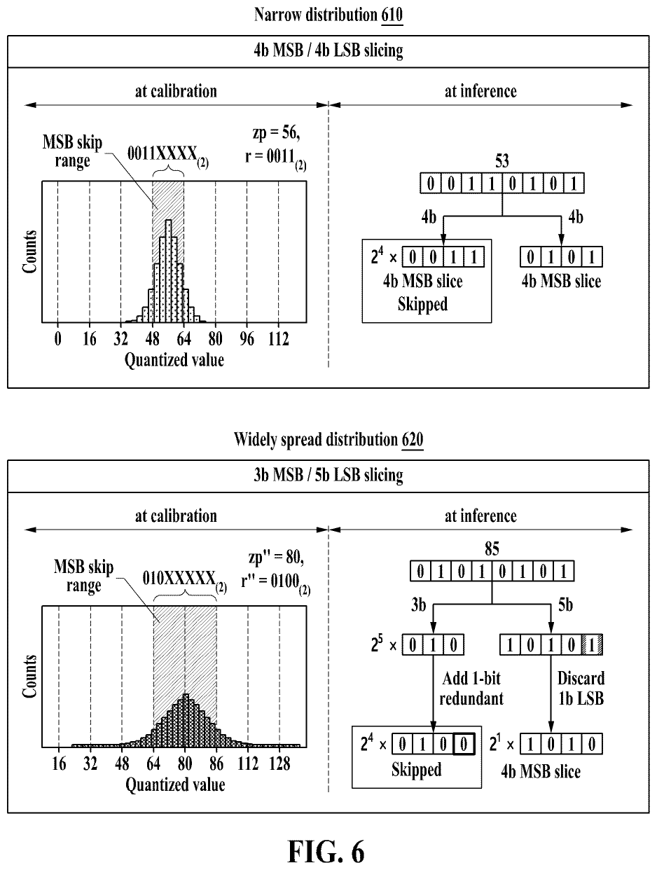

FIG. 6 is a conceptual diagram illustrating a distribution-based slicing (DBS) technique applying a bit-slicing scheme differently depending on distribution characteristics of data, according to an embodiment. The configurations and operations described with reference to FIGS. 1 to 5 may be applied in a similar manner or with slight modifications to the embodiment of FIG. 6. Accordingly, in the description of FIG. 6, a detailed description of the substantially similar parts already described with reference to FIGS. 1 to 5 will be omitted.

Data processed in each layer of a deep learning model according to an embodiment may have different distribution characteristics. For example, some data may have a narrow distribution 610 that is concentrated around a predetermined value, while other data may have a widely spread distribution 620 that is spread over a wide range.

The upper part of FIG. 6 may illustrate a process for processing data having the narrow distribution 610. When the data distribution is narrow, a standard slicing scheme may be applied, such as dividing 8-bit data into a 4-bit high-order bit slice (MSB slice) and a 4-bit low-order bit slice (least significant bit (LSB) slice). For example, 8-bit data “53” (00110101) may be split into a 4-bit MSB slice “0011” and a 4-bit LSB slice “0101”. In this case, the MSB slice “0011” may match a predetermined value pattern r, and a corresponding operation may be skipped.

The lower part of FIG. 6 may illustrate a process for processing data having the widely spread distribution 620. When the data distribution is widely spread, applying standard 4-bit MSB slicing may make it difficult to use sparsity because a slice skip range (e.g., MSB skip range) for skipping operations may become relatively narrow. In this case, a slicing scheme that sets a bit-width of a high-order bit slice to a smaller value to make an operation skip range wider, for example, a 3-bit MSB/5-bit LSB slicing scheme, may be applied. For example, 8-bit data “85” (01010101) may be split into a 3-bit MSB slice “010” and a 5-bit LSB slice “10101”.

When operation units of an acceleration apparatus operate with a fixed bit-width (e.g., 4 bits), a separate conversion process may be performed to process variable-sized slices. For example, a 3-bit MSB slice “010” may be converted to a 4-bit slice “0100” with one or more redundant bits added to match a data path width of hardware. For example, a 5-bit LSB slice “10101” may be converted to a 4-bit slice “1010” by discarding a portion (e.g., a lowest 1 bit) of the low-order bits. This distribution-based slicing technique may optimize the efficiency of operation skipping for various data distributions.

The specific numerical values and configurations of data values, bit-widths, slicing schemes, and the like shown in FIG. 6 may be examples for ease of description, and the scope of the distribution-based slicing technique is not limited by the examples.

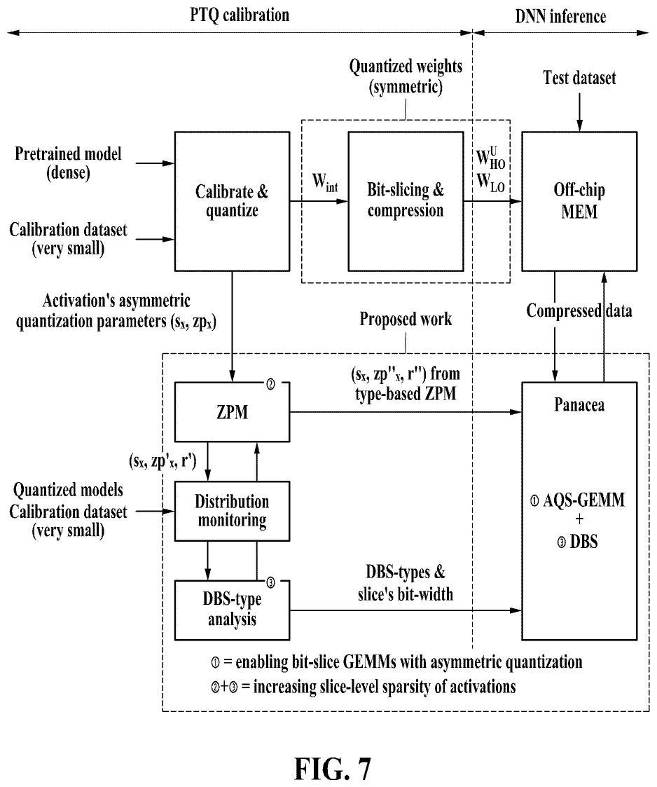

FIG. 7 is a flowchart illustrating an overall data processing flow including a post-training quantization (PTQ) calibration operation and a DNN inference operation, according to an embodiment. The configurations and operations described with reference to FIGS. 1 to 6 may be applied in a similar manner or with slight modifications to the embodiment of FIG. 7. Accordingly, in the description of FIG. 7, a detailed description of the substantially similar parts already described with reference to FIGS. 1 to 6 will be omitted.

The PTQ calibration operation shown on the left may be a process of optimizing a deep learning model and quantization parameters before performing actual inference. This operation may receive as an input a pre-trained dense model and a small calibration dataset.

For weights, quantization and calibration may be performed based on the calibration dataset to generate a weight matrix Wᵢₙₜ in integer form. For example, symmetric quantization may be applied in this process. Afterwards, the integer weight matrix may be divided into a high-order bit slice matrix W_{HO} and a low-order bit slice matrix W_{LO} through a bit-slicing and compression process, compressed, and stored in an off-chip memory (e.g., off-chip MEM).

For activation, initial asymmetric quantization parameters, for example, a scale factor Sₓ and a zero-point zpₓ, may be computed via the calibration dataset.

The proposed work may further optimize these initial quantization parameters. First, the initial parameters may be passed to a ZPM module (e.g., operation \textcircled{2}). At the same time, the calibration dataset may be input to a quantized model so that the distribution of activation values may be monitored (e.g., Distribution monitoring). The monitored distribution may be passed to a DBS-type analysis module, so that a slicing scheme suitable for each data distribution may be determined (e.g., operation \textcircled{3}). Finally, results of the ZPM and DBS-type analysis may be combined to generate optimized quantization parameters sₓ, zp_{x″}, and r″ and DBS type and slice bit-width information.

The DNN inference operation shown on the right may be a process of performing deep learning operations on actual input data (e.g., Test dataset). Compressed weight data may be loaded from the off-chip memory and input data may be passed to an acceleration apparatus, for example a Panacea apparatus. A Panacea apparatus according to an embodiment may be a deep learning acceleration apparatus in which its detailed hardware architecture is illustrated in FIG. 3. The Panacea apparatus may perform operations using the optimized quantization parameters generated in the PTQ calibration operation. Specifically, the Panacea apparatus may perform an AQS-GEMM operation activating a bit-slice GEMM for asymmetric-quantized activation (e.g., operation \textcircled{1}) and apply a slicing scheme determined according to the distribution (e.g., DBS).

Here, operation \textcircled{1} may correspond to a technique enabling bit-slice GEMM in an asymmetric quantization environment, and operations \textcircled{2} and \textcircled{3} may correspond to optimization techniques that increase computational efficiency by increasing the slice-level sparsity of activation data.

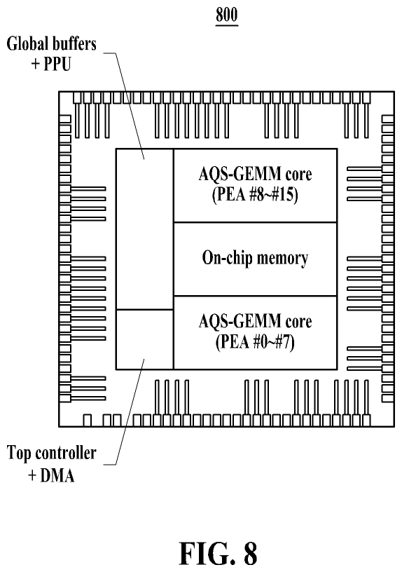

FIG. 8 is a diagram illustrating a layout of major components of a deep learning acceleration apparatus implemented on an integrated circuit (IC), according to an embodiment. The configurations and operations described with reference to FIGS. 1 to 7 may be applied in a similar manner or with slight modifications to the embodiment of FIG. 8. Accordingly, in the description of FIG. 8, a detailed description of the substantially similar parts already described with reference to FIGS. 1 to 7 will be omitted.

Referring to FIG. 8, a layout 800 according to an embodiment may include a plurality of functional blocks. For example, on-chip memory may be placed in a central portion of the layout 800. AQS-GEMM cores may be placed at the top and bottom of the on-chip memory, respectively. The AQS-GEMM cores placed at the top may include PEAs #8 to #15, and the AQS-GEMM cores placed at the bottom may include PEAs #0 to #7.

Additionally, global buffers and a PPU may be placed at the upper left of the layout 800, and a top controller and a direct memory access (DMA) controller may be placed at the lower left. This layout may show an embodiment of how the hardware architecture described in FIG. 3 may be physically laid out and implemented on an actual semiconductor chip.

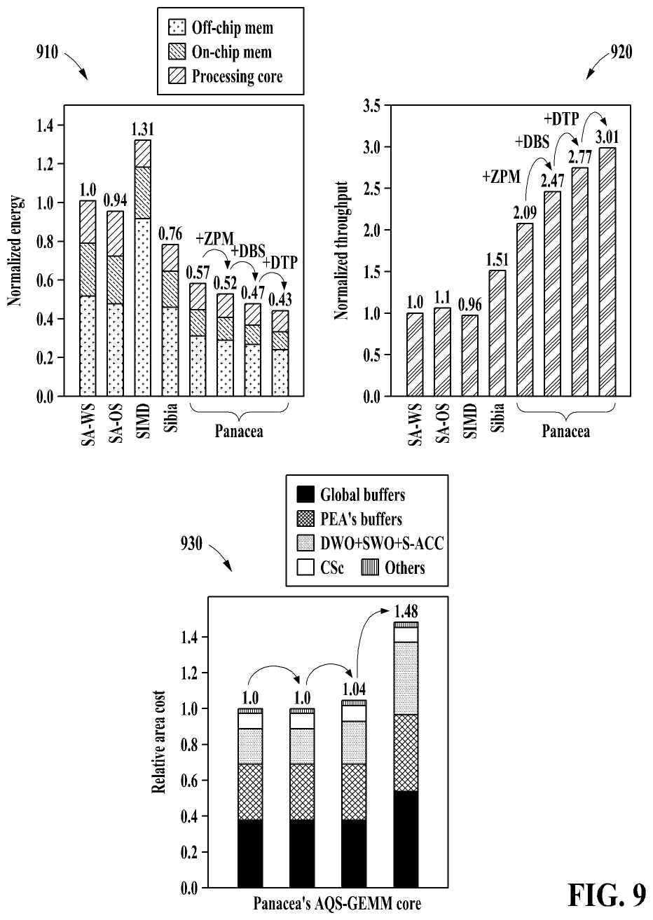

FIG. 9 is a diagram illustrating graphs comparing and evaluating the performance of deep learning acceleration apparatuses from various aspects. The configurations and operations described with reference to FIGS. 1 to 8 may be applied in a similar manner or with slight modifications to the embodiment of FIG. 9. Accordingly, in the description of FIG. 9, a detailed description of the substantially similar parts already described with reference to FIGS. 1 to 8 will be omitted.

FIG. 9 may include a normalized energy graph 910, a normalized throughput graph 920, and a relative area cost graph 930.

Each graph may compare the performance of a plurality of underlying architectures, for example, SA-WS, SA-OS, SIMD, and Sibia, with the proposed acceleration apparatus, Panacea. The performance of the proposed acceleration apparatus may be shown to change in stages starting with the application of an AQS-GEMM operation scheme, and gradually adding ZPM, DBS, and double tile processing (DTP) technologies.

The normalized energy graph 910 on the left may illustrate energy consumption for a plurality of deep learning models (e.g., GPT-2, DeiT-base, BERT). Energy consumption may be broken down into off-chip memory accesses, on-chip memory accesses, and processing core operations. As AQS-GEMM, ZPM, DBS, and DTP technologies are sequentially applied, energy consumption, especially related to memory access, may be gradually reduced, thereby improving overall energy efficiency.

The normalized throughput graph 920 on the right may illustrate throughput for identical deep learning models. As optimization techniques such as ZPM, DBS, and DTP are added, the overall throughput of the acceleration apparatus may be progressively improved.

The relative area cost graph 930 on the bottom may illustrate the relative hardware area cost of the AQS-GEMM core. Area costs may be expressed as global buffers, PEA's buffers, CSs, and operation units (e.g., DWO+SWO+S-ACC). The application of ZPM technology may have little impact on area cost, while the application of DBS and DTP technologies may increase area cost somewhat due to additional hardware components (e.g., shift units, additional buffers). These graphs may be used to analyze the trade-off between performance and energy efficiency improvements and hardware area costs.

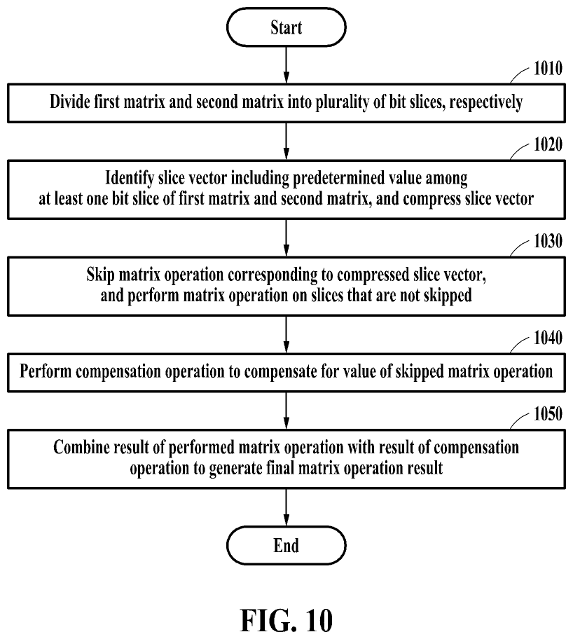

FIG. 10 is a flowchart illustrating a matrix operation method. The configurations and operations described with reference to FIGS. 1 to 9 may be applied in a similar manner or with slight modifications to the embodiment of FIG. 10. Accordingly, in the description of FIG. 10, a detailed description of the substantially similar parts already described with reference to FIGS. 1 to 9 will be omitted.

Operations of FIG. 10 may be performed in the shown order and manner. However, the order of some operations may be changed, or some operations may be omitted, without departing from the spirit and scope of the shown embodiment. The operations shown in FIG. 10 may be performed in parallel or simultaneously.

In operation 1010, an acceleration apparatus according to an embodiment may divide a first matrix and a second matrix into a plurality of bit slices, respectively. For example, the first matrix may be a symmetric quantized weight matrix, and the second matrix may be an asymmetric-quantized activation matrix. The dividing into bit slices may include a process of dividing data in each matrix into a high-order bit slice and a low-order bit slice.

In operation 1020, the electronic device may identify a slice vector including a predetermined value among at least one bit slice of the first matrix and the second matrix, and compress the identified slice vector. In an embodiment, the predetermined value may be 0, which may be identified in a high-order bit slice of the symmetric quantized weight matrix. In another embodiment, the predetermined value may be a non-zero value, which may be identified in a high-order bit slice of the asymmetric-quantized activation matrix. Additionally, the electronic device may perform an optimization process to determine a bit-width of a bit slice by adjusting a zp value used in an asymmetric quantization process or analyzing a value distribution of a matrix, to increase the identification frequency of the slice vector.

In operation 1030, the electronic device may skip a matrix operation corresponding to the compressed slice vector and perform a matrix operation on uncompressed slices. The skipping of an operation may refer to not performing the usual multiply-and-accumulate (MAC) operation. In an embodiment, an operation having sparse characteristics and an operation having dense characteristics may be processed in parallel on different operators.

In operation 1040, the electronic device may perform a compensation operation to compensate for a value of the skipped matrix operation. When the predetermined value is a non-zero value, a result value of the skipped operation may not be 0, so a compensation operation may be performed to ensure the accuracy of the final result. In an embodiment, the compensation operation may be performed efficiently by reusing bit slices of the first matrix used for the matrix operations on the uncompressed slices in operation 1030.

In operation 1050, the electronic device may combine a result of the matrix operation performed in operation 1030 with a result of the compensation operation performed in operation 1040 to generate a final matrix operation result.

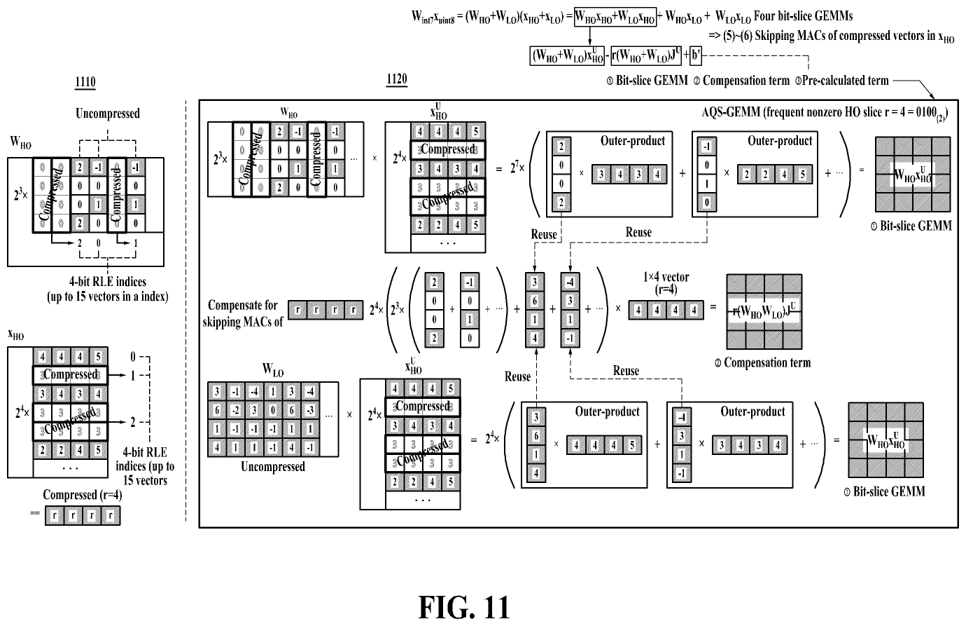

FIG. 11 is a diagram conceptually illustrating a specific execution process of an AQS-GEMM operation. The configurations and operations described with reference to FIGS. 1 to 10 may be applied in a similar manner or with slight modifications to the embodiment of FIG. 11. Accordingly, in the description of FIG. 11, a detailed description of the substantially similar parts already described with reference to FIGS. 1 to 10 will be omitted.

An example 1110 on the left side of FIG. 11 may illustrate a compression process. A high-order bit weight matrix W_{HO} and a high-order bit activation matrix X_{HO} may each be compressed into slice vector units. For example, first and fourth column vectors of W_{HO} may be uncompressed because all elements are not 0, while the second and third column vectors may be compressed because all elements are 0. Similarly, a first row vector of X_{HO} may be uncompressed because all elements are not equal to a predetermined non-zero value r (where r=4), whereas second and third row vectors may be compressed because all elements are equal to r=4. The positions and consecutive numbers of compressed vectors may be expressed via 4-bit RLE indices.

An example 1120 on the right side of FIG. 11 may illustrate a process in which actual operations are performed based on compressed data. An overall matrix multiplication operation may be conceptually decomposed into three parts.

The first is a (1) bit-slice GEMM part. This part may include operations between uncompressed slice vectors. For example, an outer-product operation may be performed between an uncompressed first column vector [2, 0, 0, 2] of W_{HO} and an uncompressed first row vector [4, 4, 4, 5] of

$${X}_{HO}^{U} .$$

Similarly, an outer-product operation may also be performed between uncompressed column vectors of a low-order bit weight matrix W_{LO} and uncompressed row vectors of

$${X}_{HO}^{U} .$$

The second is a \textcircled{2} compensation term part. This part may be a process of calculating an operation value corresponding to a compressed activation slice vector, i.e., rrrr (where r=4). Instead of loading new data from memory for this operation, the weight slices that are already loaded for the operation of the \textcircled{1} bit-slice GEMM part may be reused. Specifically, as shown in FIG. 11, the uncompressed column vectors of W_{HO} and the uncompressed column vectors of W_{LO} are added, respectively, and then the added result is computed with a 1×4 vector [4, 4, 4, 4] configured as r=4, so that the compensation term r(W_{HO}+W_{LO})J^{U} may be calculated. This reuse of data may maximize computational efficiency by eliminating additional memory accesses.

The third may be a \textcircled{3} pre-calculated term part. This part may be an offset term b′ that may be pre-calculated before an operation begins, and may be added to the final result to ensure the accuracy of the overall operation.

Finally, the operation results of the above-described three parts may be combined to produce the same result as the original matrix multiplication operation Wᵢₙₜ*Xᵤᵢₙₜ8. Through this process, complex MAC operations on compressed vectors may be efficiently skipped and replaced with simple compensation operations.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include multiple processing elements and multiple types of processing elements. For example, a processing device may include a plurality of processors or a processor and a controller. In addition, different processing configurations are possible, such as parallel processors.

Software may include a computer program, a piece of code, an instruction, or combinations thereof, to independently or collectively instruct or configure the processing device to operate as desired. Software and/or data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, structure, device, or circuit are combined in a different manner, and/or replaced or supplemented by other components or their equivalents.

Therefore, other implementations, other embodiments, and equivalents to the claims are also within the scope of the following claims.

What is claimed is:

1. A matrix operation method comprising:
dividing a first matrix and a second matrix into a plurality of bit slices, respectively;
identifying a slice vector comprising a predetermined value among at least one bit slice of the first matrix and the second matrix, and compressing the slice vector;
skipping a matrix operation corresponding to the compressed slice vector, and performing a matrix operation on slices that are not skipped;
performing a compensation operation to compensate for a value of the skipped matrix operation; and
combining a result of the performed matrix operation with a result of the compensation operation to generate a final matrix operation result.

2. The matrix operation method of claim 1, wherein a matrix comprising the slice vector comprises an asymmetric-quantized matrix.

3. The matrix operation method of claim 2, further comprising:
adjusting a zero-point value used in the asymmetric quantization.

4. The matrix operation method of claim 2, further comprising:
analyzing a value distribution of the asymmetric-quantized matrix; and
determining a bit-width of the bit slice, based on the analyzed value distribution.

5. The matrix operation method of claim 2, wherein the asymmetric-quantized matrix comprising the slice vector comprises the second matrix,
the second matrix comprises an activation matrix, and
the first matrix comprises a weight matrix.

6. The matrix operation method of claim 1, wherein the performing of the matrix operation comprises:
processing a sparse operation corresponding to the compressed slice vector and a dense operation corresponding to an uncompressed slice vector in parallel on different operators.

7. The matrix operation method of claim 6, wherein the performing of the matrix operation comprises:
in response to throughput of the sparse operation being less than throughput of the dense operation, additionally assigning and processing a dense operation to a sparse operator in an idle state.

8. The matrix operation method of claim 1, wherein the performing of the compensation operation comprises:
performing the compensation operation by reusing the bit slices of the first matrix used for the matrix operation on the slices that are not skipped.

9. A non-transitory computer-readable storage medium storing instructions that, when executed by a processor, cause the processor to perform the method of claim 1.

10. A deep learning acceleration apparatus for performing a matrix operation, the deep learning acceleration apparatus comprising:
memory storing matrix data;
one or more first operation units electrically connected to the memory, and configured to perform a first matrix operation comprising at least one high-order bit slice among high-order bit slices and low-order bit slices divided from a first matrix and a second matrix;
one or more second operation units configured to perform a second matrix operation between the low-order bit slices;
one or more compensation units configured to calculate an operation value corresponding to a compressed slice vector comprising a predetermined value among the high-order bit slices; and
a post-processing unit configured to combine a result of the first matrix operation and the second matrix operation with the operation value of the one or more compensation units to generate a final matrix operation result,
wherein the first operation unit does not perform the first matrix operation corresponding to the compressed slice vector.

11. The deep learning acceleration apparatus of claim 10, wherein the deep learning acceleration apparatus is configured to perform an operation on an asymmetric-quantized matrix, and
the one or more compensation units are configured to calculate an operation value corresponding to a slice vector comprising a predetermined non-zero value that occurs in the asymmetric-quantized matrix.

12. The deep learning acceleration apparatus of claim 10, wherein the one or more compensation units are configured to calculate the operation value by reusing bit slices of the first matrix provided to the first operation unit for the first matrix operation.

13. The deep learning acceleration apparatus of claim 10, wherein the post-processing unit further comprises:
a shift unit configured to adjust a bit-width of the bit slices according to a value distribution of the matrix data.

14. The deep learning acceleration apparatus of claim 10, wherein the first operation unit is configured to additionally assign and process the second matrix operation, in response to sparsity of the high-order bit slices being greater than or equal to a predetermined threshold value.

15. The deep learning acceleration apparatus of claim 10, wherein the first matrix comprises a weight matrix, and
the second matrix comprises an activation matrix.

16. The deep learning acceleration apparatus of claim 10, wherein the deep learning acceleration apparatus further comprises:
a register configured to store an adjusted zero-point value provided externally,
wherein the one or more compensation units are configured to calculate the operation value using an adjusted zero-point value stored in the register.
